(19) United States
(12) Patent Application Publication
(10) Pub. No.: US 2025/0253353 A1
(43) Pub. Date: Aug. 7, 2025

(54) ALL-SOLID-STATE BATTERY INCLUDING A COPPER CURRENT COLLECTOR

(71) Applicants: Hyundai Motor Company, Seoul (KR); Kia Corporation, Seoul (KR)

(72) Inventors: Yun Sung Kim, Seoul (KR); Ga Hyeon Im, Seoul (KR); Kyu Joon Lee, Seoul (KR); So Young Lee, Seoul (KR); Hong Seok Min, Seoul (KR); Yoon Kwang Lee, Seoul (KR)

(21) Appl. No.: 18/819,044

(22) Filed: Aug. 29, 2024

(30) Foreign Application Priority Data
Feb. 5, 2024 (KR) 10-2024-0017118

(51) Int. Cl. H01M 4/66; H01M 4/62; H01M 10/0562

(52) U.S. Cl. CPC H01M 4/667; H01M 4/623; H01M 4/625; H01M 4/661; H01M 10/0562; H01M 2220/20

(57) ABSTRACT

Disclosed is an all-solid-state comprising: an anode current collector; a first coating layer disposed on the anode current collector and comprising a first anode active material, a first conductive material, and a first binder; a second coating layer disposed on the first coating layer and comprising a second anode active material, a second conductive material, a solid electrolyte, and a second binder; a solid electrolyte layer disposed on the second coating layer; a cathode layer disposed on the solid electrolyte layer; and a cathode current collector disposed on the cathode layer.

### CROSS-REFERENCE TO RELATED APPLICATION

This application claims, under 35 U.S.C. § 119 (a), the benefit of Korean Patent Application No. 10-2024-0017118, filed on Feb. 5, 2024, the entire contents of which are incorporated herein by reference.

### BACKGROUND

### Technical Field

The present disclosure relates to an all-solid-state battery including a copper current collector and a polar binder.

### Background

An all-solid-state battery including a sulfide-based solid electrolyte uses nickel or stainless steel as an anode current collector. Although nickel and stainless steel are expensive and have poorer mechanical properties compared to a copper current collector, the sulfide-based solid electrolyte reacts with the copper current collector, making it unsuitable for use.

Moreover, the use of a nonpolar binder is forced due to use of a nonpolar solvent that does not react with the sulfide-based solid electrolyte in the process of manufacturing an anode. In general, when a nonpolar binder is applied, adhesion between the current collector and the anode is low.

### SUMMARY

An object of the present disclosure is to provide a means for using a copper current collector in an all-solid-state battery including a sulfide-based solid electrolyte.

Another object of the present disclosure is to provide a means for using a polar binder in an all-solid-state battery including a sulfide-based solid electrolyte.

The objects of the present disclosure are not limited to the foregoing. The objects of the present disclosure will be able to be clearly understood through the following description and to be realized by the means described in the claims and combinations thereof.

The present disclosure provides an all-solid-state battery, including an anode current collector, a first coating layer disposed on the anode current collector and including a first anode active material, a first conductive material, and a first binder, a second coating layer disposed on the first coating layer and including a second anode active material, a second conductive material, a solid electrolyte, and a second binder, a solid electrolyte layer disposed on the second coating layer, a cathode layer disposed on the solid electrolyte layer, and a cathode current collector disposed on the cathode layer.

One surface of the anode current collector may be covered with the first coating layer, such that the anode current collector and the second coating layer are not in contact.

The entirety of one surface of the anode current collector may be covered with the first coating layer, so that the anode current collector and the second coating layer are not in contact.

The solid electrolyte may include a sulfide-based solid electrolyte.

The second binder may include a nonpolar binder.

The second binder may include at least one selected from the group consisting of butadiene rubber, styrene butadiene rubber, an acrylate-based binder, and combinations thereof.

The first conductive material may include at least one selected from the group consisting of graphitic carbon, exfoliated graphite nanoplatelets, carbon nanotubes, carbon black, carbon nanofiber, and combinations thereof.

The second conductive material may include at least one selected from the group consisting of graphitic carbon, exfoliated graphite nanoplatelets, carbon nanotubes, carbon black, carbon nanofiber, and combinations thereof.

The first binder may include a polar binder. The first binder may include a nonpolar binder.

The first binder may include at least one selected from the group consisting of polyvinylidene fluoride, polyacrylic acid, poly(ethylene oxide), carboxymethyl cellulose, carboxymethyl chitosan, alginate, 3,4-ethylenedioxythiophene, polyaniline, polypyrrole, an acrylonitrile multi-copolymer binder, polyvinyl alcohol, polyethylene glycol, polyamide imide, polystyrene sulfonate, and combinations thereof.

The first coating layer may be free from a solid electrolyte. The first coating layer may be substantially free from a solid electrolyte.

The thickness of the first coating layer may be about 10 μm or less.

The anode current collector may include a metal selected from the group consisting of copper, nickel, and stainless steel. The metal may be copper.

Also provided is an all-solid-state battery including an anode current collector comprising copper; a first coating layer disposed on the anode current collector and comprising a first anode active material, a first conductive material, and a first binder comprising a polar binder; a second coating layer disposed on the first coating layer and comprising a second anode active material, a second conductive material, a sulfide-based solid electrolyte, and a second binder; a solid electrolyte layer disposed on the second coating layer; a cathode layer disposed on the solid electrolyte layer; and a cathode current collector disposed on the cathode layer.

One surface of the anode current collector may be covered with the first coating layer, such that the anode current collector and the second coating layer are not in contact. The first coating layer may be substantially free from a solid electrolyte. A thickness of the first coating layer may be about 10 μm or less.

The first coating layer may be free from a solid electrolyte.

Also provided is a vehicle including the all-solid-state battery described above.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows an all-solid-state battery according to the present disclosure;

FIG. 2 shows a scanning electron microscope (SEM) image of the cross-section of an all-solid-state battery according to Example;

FIG. 3 shows an SEM image of the surface of the anode current collector after charging and discharging of an all-solid-state battery according to Comparative Example 1;

FIG. 4 shows an SEM image of the cross-section of an all-solid-state battery according to Comparative Example 2;

FIG. 5 shows results of evaluation of adhesion between the anode current collector and the first coating layer and the second coating layer in the all-solid-state batteries according to Example and Comparative Example 1;

FIG. 6 shows a charge/discharge curve of the all-solid-state battery according to Example;

FIG. 7 shows results of measurement of capacity retention of the all-solid-state battery according to Example; and

FIG. 8 shows a charge/discharge curve of the all-solid-state battery according to Comparative Example 2.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

As used herein, the term “free from” means that the specified substance, component, or characteristic is not present in the composition, device, or method in any measurable amount. Specifically, “free from” indicates that the substance, component, or characteristic is present, if at all, only as an impurity or in trace amounts that do not affect the performance or properties of the composition, device, or method.

As used herein, the term “substantially free from” means that the specified substance, component, or characteristic is present, if at all, only in negligible amounts that do not materially affect the performance, properties, or function of the composition, device, or method, for example being present in an amount of less than 5% by weight.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

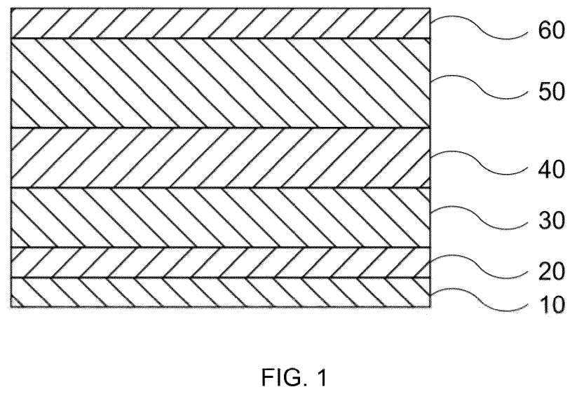

FIG. 1 shows an all-solid-state battery according to the present disclosure. The all-solid-state battery may include an anode current collector 10, a first coating layer 20 disposed on the anode current collector 10, a second coating layer 30 disposed on the first coating layer 20, a solid electrolyte layer 40 disposed on the second coating layer 30, a cathode layer 50 disposed on the solid electrolyte layer 40, and a cathode current collector 60 disposed on the cathode layer 50.

The anode current collector 10 may be a plate-type substrate having electrical conductivity. Specifically, the anode current collector 10 may be in the form of a sheet, a thin film, or a foil.

The thickness of the anode current collector 10 is not particularly limited and may be, for example, 1 μm to 500 μm.

The anode current collector 10 may include copper (Cu), nickel (Ni), stainless steel, or other materials. Preferably, the anode current collector 10 includes copper (Cu). Copper is inexpensive and has high ductility compared to nickel, contributing to an improvement in the performance of all-solid-state batteries.

As shown in FIG. 1, the entirety of one surface of the anode current collector 10 is covered with the first coating layer 20, so that the anode current collector 10 and the second coating layer 30 may not be in contact. Specifically, since the sulfide-based solid electrolyte of the second coating layer 30 does not come into contact with the anode current collector 10, a copper current collector that corrodes by the sulfide-based solid electrolyte may be used as the anode current collector 10.

The second coating layer 30 may be in the shape of a sheet and have at least two opposing major surfaces. Each of the two major surfaces may include not only a mathematical plane but also a certain curved surface in part, and may have irregularities generated during formation of the second coating layer 30. In this sense, the sheet shape is not limited to a relatively thin cuboid.

The distance between two opposing major surfaces may be the thickness of the second coating layer 30. The length of the second coating layer 30 in the first direction (e.g., width direction) perpendicular to the thickness direction is greater than the thickness. Also, the length of the second coating layer 30 in the second direction (e.g., longitudinal direction) perpendicular to the thickness direction and the first direction is greater than the thickness.

The thickness of the second coating layer 30 is not particularly limited, but may be 1 μm to 100 μm. The thickness of the second coating layer 30 may indicate an average value when a measurement target is measured at 5 points. Also, the thickness of the second coating layer 30 may indicate a thickness upon discharging of the all-solid-state battery.

The second coating layer 30 may include a second anode active material, a solid electrolyte, a second conductive material, and a second binder.

The second anode active material may include at least one selected from the group consisting of a silicon-based anode active material, a carbon-based anode active material, and combinations thereof.

The silicon-based anode active material may include at least one selected from the group consisting of Si, SiOₓ (0<x<2), Si-containing alloys, and combinations thereof. The Si-containing alloy may include an alloy of Si and any metal selected from among alkali metals, alkaline earth metals, Group 13 elements, Group 14 elements, transition metals, rare earth elements, and combinations thereof.

The carbon-based anode active material may include graphite, such as mesocarbon microbeads (MCMB) and highly oriented pyrolytic graphite (HOPG), or amorphous carbon such as hard carbon and soft carbon.

The second anode active material may be a composite of the carbon active material and the metal active material. For example, the surface of the carbon active material may be coated with the metal active material, or the surface of the metal active material may be coated with the carbon active material.

In addition thereto, the second anode active material may also include lithium titanate such as Li₄Ti₅O₁₂.

The solid electrolyte may include a sulfide-based solid electrolyte. Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂S₁₂, and the like.

As described above, the second coating layer 30 may not be in contact with the anode current collector 10 due to the presence of the first coating layer 20. Therefore, even when a copper current collector is used as the anode current collector 10, the anode current collector 10 may be protected from corrosion by the sulfide-based solid electrolyte contained in the second coating layer 30.

The second conductive material may include at least one selected from the group consisting of graphitic carbon, exfoliated graphite nanoplatelets, carbon nanotubes, carbon black, carbon nanofiber, and combinations thereof. Here, the term “exfoliated graphite nanoplatelets” may refer to a material composed of several graphene sheets. The exfoliated graphite nanoplatelets may have a thickness of about 5 nm with a platelet size of about 500 nm to 10 μm.

The second binder may include a nonpolar binder. The nonpolar binder may include at least one selected from the group consisting of butadiene rubber, styrene butadiene rubber, an acrylate-based binder, and combinations thereof. The type of acrylate-based binder is not particularly limited. Examples of the acrylate-based binder may include polyethylene glycol diacrylate, polyethylene glycol phosphate diacrylate, polyacrylate, polymethylmethacrylate, polyisobutylmethylmethacrylate, polybutylacrylate, and the like. As referred to herein, a nonpolar binder suitably may be free or substantially free (e.g. present in less than 10, 9 8, 7, 6, 5, 4, 3, 2, 1 or 0.5 percent of resin units of a nonpolar binder) polar moieties such as nitro, polar halogen such as trifluoromethyl, acids such as carboxy acids or sulfonic acids.

The second coating layer 30 may include 60 wt % to 80 wt % of the second anode active material, 10 wt % to 35 wt % of the solid electrolyte, 1 wt % to 10 wt % of the second conductive material, and 1 wt % to 10 wt % of the second binder. The amount of each component is not limited to the above numerical range and may be appropriately adjusted depending on the desired capacity, performance, etc., of the all-solid-state battery.

The first coating layer 20 may include a first anode active material, a first conductive material, and a first binder. Since the first coating layer 20 includes the first conductive material having electrical conductivity, electrons are able to move between the anode current collector 10 and the second coating layer 30.

The first anode active material may include at least one selected from the group consisting of a silicon-based anode active material, a carbon-based anode active material, and combinations thereof. The first anode active material may be the same as or different from the second anode active material.

The first conductive material may include at least one selected from the group consisting of graphitic carbon, exfoliated graphite nanoplatelets, carbon nanotubes, carbon black, carbon nanofiber, and combinations thereof. The first conductive material may be the same as or different from the second conductive material.

The first coating layer 20 may not include a sulfide-based solid electrolyte. Accordingly, even when the first coating layer 20 and the anode current collector 10 are in contact, the anode current collector 10 may be protected from corrosion. Also, in manufacturing the first coating layer 20, a polar solvent may be applied because a sulfide-based solid electrolyte is not used. Thus, when manufacturing the first coating layer 20, a polar binder with excellent adhesion may be used, thereby enhancing adhesion between the first coating layer 20 and the anode current collector 10.

Since the first coating layer 20 is a very thin film, movement of lithium ions may not greatly deteriorate despite the absence of a solid electrolyte. The thickness of the first coating layer 20 may be 10 μm or less. The lower limit of the thickness of the first coating layer 20 is not particularly limited and may be 1 μm or more, 2 μm or more, 3 μm or more, 4 μm or more, or 5 μm or more. If the thickness of the first coating layer 20 exceeds 10 μm, the movement speed of lithium and electrons may decrease, which may cause a short circuit in the all-solid-state battery.

Since the first coating layer 20 does not include a sulfide-based solid electrolyte, a polar solvent may be used in the manufacturing process thereof, and thus excellent adhesion may result. Therefore, the first binder may include a polar binder. The polar binder may include at least one selected from the group consisting of polyvinylidene fluoride, polyacrylic acid, poly(ethylene oxide), carboxymethyl cellulose, carboxymethyl chitosan, alginate, 3,4-ethylenedioxythiophene, polyaniline, polypyrrole, an acrylonitrile multi-copolymer binder, polyvinyl alcohol, polyethylene glycol, polyamide imide, polystyrene sulfonate, and combinations thereof. However, the first binder is not limited to the polar binder, and may include a nonpolar binder, or may include a mixed binder of the polar binder and the nonpolar binder. The nonpolar binder may include at least one selected from the group consisting of butadiene rubber, styrene butadiene rubber, an acrylate-based binder, and combinations thereof. And the nonpolar binder may be the same as or different from the second binder.

The first coating layer 20 may include 1 wt % to 10 wt % of the first anode active material, 90 wt % to 99 wt % of the first conductive material, and 1 wt % to 10 wt % of the first binder. Here, the amount of each component is not limited thereto and may be appropriately adjusted in consideration of adhesion between the first coating layer 20 and the anode current collector 10, performance of the all-solid-state battery, etc.

The solid electrolyte layer 40 may have a sheet shape having at least two opposing major surfaces. Each of the two major surfaces may include not only a mathematical plane, but also a certain curved surface in part, and may have irregularities generated during the formation of the solid electrolyte layer 40. In this sense, the sheet shape is not limited to a relatively thin cuboid.

In the sheet-shaped solid electrolyte layer 40, the distance between two opposing major surfaces may be the thickness of the solid electrolyte layer 40. The length of the solid electrolyte layer 40 in the first direction (e.g., width direction) perpendicular to the thickness direction is greater than the thickness. Also, the length of the solid electrolyte layer 40 in the second direction (e.g., longitudinal direction) perpendicular to both the thickness direction and the first direction is greater than the thickness.

The thickness of the solid electrolyte layer 40 is not particularly limited, but may be 1 μm to 100 μm. The thickness of the solid electrolyte layer 40 may indicate an average value when a measurement target is measured at 5 points.

The solid electrolyte layer 40 may include a solid electrolyte with lithium ion conductivity and a binder.

The solid electrolyte may be the same as or different from the solid electrolyte of the second coating layer 30. The solid electrolyte may include at least one selected from the group consisting of an oxide-based solid electrolyte, a sulfide-based solid electrolyte, and combinations thereof. Also, the solid electrolyte may be crystalline, amorphous, or in a mixed state thereof.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ (PO₄)₃), and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂S₁₂, and the like.

Preferably, the solid electrolyte includes a sulfide-based solid electrolyte having an argyrodite crystal structure. The sulfide-based solid electrolyte having the argyrodite crystal structure may include at least one selected from the group consisting of Li_{7-y}PS_{6-y}Ha_{y} (in which Ha includes Cl, Br, or I, and y satisfies 0<y≤2), Li_{7-z}PS_{6-z}(Ha1_{1-b}Ha2_{b})_{z} (in which Ha1 and Ha2 are different from each other, each independently includes Cl, Br, or I, and b and z satisfy 0<b<1 and 0<z≤2), and combinations thereof.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder may exist in a granular or linear form in the solid electrolyte layer 40.

The cathode layer 50 may include a cathode active material, a solid electrolyte, a conductive material, and a binder.

The cathode active material may include a lithium transition metal oxide that stores and releases lithium.

The lithium transition metal oxide may include any material that is common in the technical field to which the present disclosure belongs. For example, the lithium transition metal oxide may include LiNiₓ₁Coₓ₂Mnₓ₃O₂ (0.65≤x1≤0.85,0.05<x2<0.25,0.03<x3<0.2, and x1+x2+x3=1).

The average particle diameter D50 of the cathode active material is not particularly limited and may be, for example, 1 μm to 20 μm. The average particle diameter D50 of the cathode active material may be measured using a commercially available laser diffraction scattering-type particle size distribution analyzer, for example, a Microtrac particle size distribution analyzer. Alternatively, 200 particles may be randomly extracted from the electron micrograph and the average particle diameter thereof may be calculated.

The cathode active material may be coated with an alkali metal oxide.

The alkali metal oxide may include an alkali metal element, a transition metal element, and a substitution element.

The alkali metal element may include at least one selected from the group consisting of lithium (Li), sodium (Na), potassium (K), and combinations thereof. Preferably, the alkali metal element includes lithium (Li).

The transition metal element may include any metal contained in alkali metal oxides commonly used in the technical field to which the present disclosure belongs. For example, the transition metal element may include at least one selected from the group consisting of niobium (Nb), tantalum (Ta), zirconium (Zr), and combinations thereof.

The solid electrolyte is responsible for the movement of lithium ions in the cathode layer 50. The solid electrolyte may be the same as or different from the solid electrolyte of the second coating layer 30 and the solid electrolyte layer 40.

The solid electrolyte may include at least one selected from the group consisting of an oxide-based solid electrolyte, a sulfide-based solid electrolyte, and combinations thereof. Also, the solid electrolyte may be crystalline, amorphous, or in a mixed state thereof.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ (PO₄) 3), and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂S₁₂, and the like.

Preferably, the solid electrolyte includes a sulfide-based solid electrolyte having an argyrodite crystal structure. The sulfide-based solid electrolyte having the argyrodite crystal structure may include at least one selected from the group consisting of Li_{7-y}PS_{6-y}Ha_{y} (in which Ha includes Cl, Br, or I, and y satisfies 0<y≤2), Li_{7-z}PS_{6-z}(Ha1_{1-b}Ha2_{b})_{z} (in which Ha1 and Ha2 are different from each other, each independently includes Cl, Br, or I, and b and z satisfy 0<b<1 and 0<z≤2), and combinations thereof.

Examples of the conductive material may include carbon black, conductive graphite, ethylene black, graphene, carbon nanotubes, carbon nanofiber, vapor grown carbon fiber, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder may exist in a granular or linear form in the cathode layer 50.

The cathode layer 50 may include 70 wt % to 90 wt % of the cathode active material, 10 wt % to 15 wt % of the solid electrolyte, 1 wt % to 5 wt % of the conductive material, and 1 wt % to 5 wt % of the binder. Here, the amount of each component may be appropriately adjusted in consideration of the desired capacity, efficiency, etc. of the all-solid-state battery.

The thickness of the cathode layer 50 is not particularly limited, but may be 1 μm to 100 μm. The thickness of the cathode layer 50 may indicate an average value when a measurement target is measured at 5 points. Also, the thickness of the cathode layer 50 may indicate a thickness upon discharging of the all-solid-state battery.

The cathode current collector 60 may include a plate-type substrate having electrical conductivity. Specifically, the cathode current collector 60 may be in the form of a sheet, a thin film, or a foil.

The cathode current collector 60 may include an aluminum foil.

The thickness of the cathode current collector 60 is not particularly limited and may be, for example, 1 μm to 500 μm.

A better understanding of the present disclosure may be obtained through the following examples. These examples are merely set forth to illustrate the present disclosure, and are not to be construed as limiting the scope of the present disclosure.

### EXAMPLE

A copper current collector was used as an anode current collector.

A first coating layer was formed by applying a slurry including a carbon-based anode active material, graphitic carbon, and polyvinylidene fluoride onto the anode current collector. The thickness of the first coating layer was set to about 7 μm. A second coating layer including a carbon-based anode active material, a sulfide-based solid electrolyte, and butadiene rubber was formed on the first coating layer.

An all-solid-state battery was completed by sequentially stacking a solid electrolyte layer including a sulfide-based solid electrolyte, a cathode layer, and a cathode current collector on the second coating layer.

### Comparative Example 1

An all-solid-state battery was manufactured using the same materials and methods as in Example 1, with the exception that the first coating layer was not formed, and the second coating layer was formed on the copper current collector.

### Comparative Example 2

An all-solid-state battery was manufactured using the same materials and methods as in Example 1, with the exception that the thickness of the first coating layer was changed to exceed 10 μm.

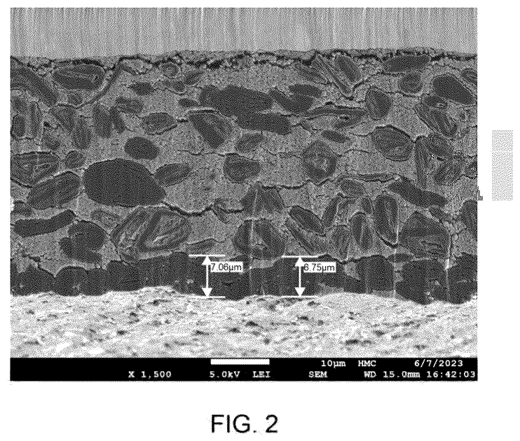

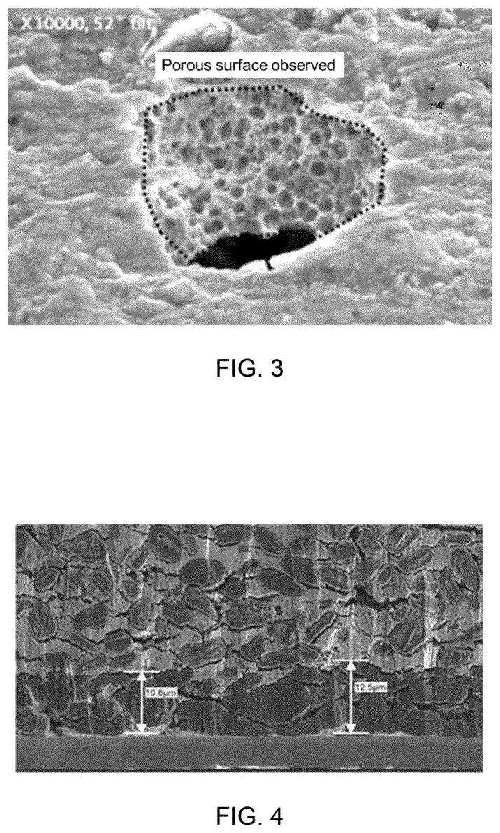

FIG. 2 shows an SEM image of the cross-section of the all-solid-state battery according to Example. FIG. 3 shows an SEM image of the surface of the anode current collector after charging and discharging of the all-solid-state battery according to Comparative Example 1. FIG. 4 shows an SEM image of the cross-section of the all-solid-state battery according to Comparative Example 2.

Referring to FIG. 3, operation of the all-solid-state battery in a state of the copper current collector and the second coating layer being in direct contact was found to cause the copper current collector to corrode due to reaction with the sulfide-based solid electrolyte.

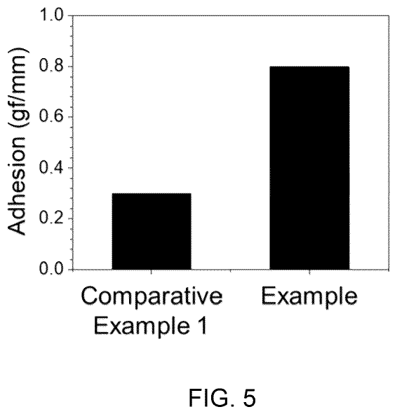

FIG. 5 shows results of evaluation of adhesion between the anode current collector and the first coating layer and the second coating layer in the all-solid-state batteries according to Example and Comparative Example 1. Referring thereto, Example in which the first coating layer is present exhibited adhesion at least two times as high as Comparative Example 1.

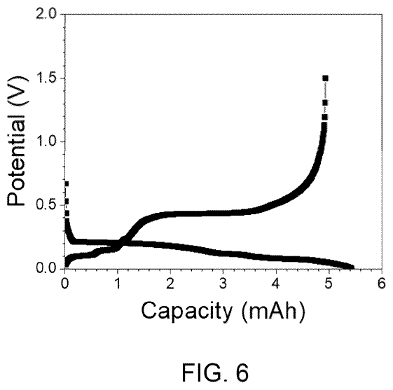

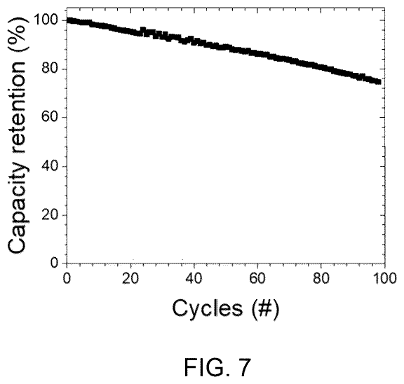

FIG. 6 shows a charge/discharge curve of the all-solid-state battery according to Example. FIG. 7 shows results of measurement of capacity retention of the all-solid-state battery according to Example. The all-solid-state battery according to the present disclosure, which includes a copper current collector and in which the first coating layer has a thickness of 10 μm or less, was found to operate normally.

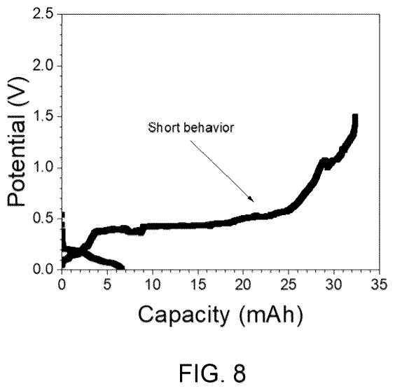

FIG. 8 shows a charge/discharge curve of the all-solid-state battery according to Comparative Example 2. Referring thereto, when the thickness of the first coating layer exceeded 10 μm, short circuit behavior resulted.

According to the present disclosure, a copper current collector can be used in an all-solid-state battery including a sulfide-based solid electrolyte. Compared to conventional all-solid-state batteries, a current collector with low cost and high ductility can be used, which can contribute to mass production and improved battery performance.

According to the present disclosure, a polar binder can be used in an all-solid-state battery including a sulfide-based solid electrolyte, thereby enhancing adhesion between the first coating layer and the second coating layer and the anode current collector.

The effects of the present disclosure are not limited to the above-mentioned effects. It should be understood that the effects of the present disclosure include all effects that can be inferred from the description of the present disclosure.

As the examples of the present disclosure have been described in detail above, the scope of the present disclosure is not limited to the aforementioned examples and various modifications and improvements made by those skilled in the art using the basic concept of the present disclosure defined in the following claims are also within the scope of the present disclosure.

What is claimed is:

1. An all-solid-state battery comprising:
an anode current collector;
a first coating layer disposed on the anode current collector and comprising a first anode active material, a first conductive material, and a first binder;
a second coating layer disposed on the first coating layer and comprising a second anode active material, a second conductive material, a solid electrolyte, and a second binder;
a solid electrolyte layer disposed on the second coating layer;
a cathode layer disposed on the solid electrolyte layer; and
a cathode current collector disposed on the cathode layer.

2. The all-solid-state battery of claim 1, wherein one surface of the anode current collector is covered with the first coating layer, such that the anode current collector and the second coating layer are not in contact.

3. The all-solid-state battery of claim 1, wherein entirety of the surface of the anode current collector is covered with the first coating layer.

4. The all-solid-state battery of claim 1, wherein the solid electrolyte comprises a sulfide-based solid electrolyte.

5. The all-solid-state battery of claim 1, wherein the second binder comprises a nonpolar binder.

6. The all-solid-state battery of claim 1, wherein the second binder comprises at least one selected from the group consisting of butadiene rubber, styrene butadiene rubber, an acrylate-based binder, and combinations thereof.

7. The all-solid-state battery of claim 1, wherein the first conductive material comprises at least one selected from the group consisting of graphitic carbon, exfoliated graphite nanoplatelets, carbon nanotubes, carbon black, carbon nanofiber, and combinations thereof.

8. The all-solid-state battery of claim 1, wherein the second conductive material comprises at least one selected from the group consisting of graphitic carbon, exfoliated graphite nanoplatelets, carbon nanotubes, carbon black, carbon nanofiber, and combinations thereof.

9. The all-solid-state battery of claim 1, wherein the first binder comprises a polar binder.

10. The all-solid-state battery of claim 1, wherein the first binder comprises a nonpolar binder.

11. The all-solid-state battery of claim 1, wherein the first binder comprises at least one selected from the group consisting of polyvinylidene fluoride, polyacrylic acid, poly(ethylene oxide), carboxymethyl cellulose, carboxymethyl chitosan, alginate, 3,4 ethylenedioxythiophene, polyaniline, polypyrrole, an acrylonitrile multi-copolymer binder, polyvinyl alcohol, polyethylene glycol, polyamide imide, polystyrene sulfonate, and combinations thereof.

12. The all-solid-state battery of claim 1, wherein the first coating layer is free from a solid electrolyte.

13. The all-solid-state battery of claim 1, wherein the first coating layer is substantially free from a solid electrolyte.

14. The all-solid-state battery of claim 1, wherein a thickness of the first coating layer is about 10 μm or less.

15. The all-solid-state battery of claim 1, wherein the anode current collector comprises a metal selected from the group consisting of copper, nickel, and stainless steel.

16. The all-solid-state battery of claim 15, wherein the metal is copper.

17. An all-solid-state battery comprising:
an anode current collector comprising copper;
a first coating layer disposed on the anode current collector and comprising a first anode active material, a first conductive material, and a first binder comprising a polar binder;
a second coating layer disposed on the first coating layer and comprising a second anode active material, a second conductive material, a sulfide-based solid electrolyte, and a second binder;
a solid electrolyte layer disposed on the second coating layer;
a cathode layer disposed on the solid electrolyte layer; and
a cathode current collector disposed on the cathode layer,
wherein one surface of the anode current collector is covered with the first coating layer, such that the anode current collector and the second coating layer are not in contact,
wherein the first coating layer is substantially free from a solid electrolyte, and
wherein a thickness of the first coating layer is about 10 μm or less.

18. The all-solid-state battery of claim 17, wherein the first coating layer is free from a solid electrolyte.

19. A vehicle comprising the all-solid-state battery of claim 1.

20. A vehicle comprising the all-solid-state battery of claim 17.
